(19) United States
(12) Patent Application Publication
(10) Pub. No.: US 2019/0191925 A1
(43) Pub. Date: Jun. 27, 2019

(54) Temperature Regulating Fluid Container Assembly

(71) Applicant: Russell Stalzer, Houston, TX (US)

(72) Inventor: Russell Stalzer, Houston, TX (US)

(21) Appl. No.: 15/849,728

(22) Filed: Dec. 21, 2017

(51) Int. Cl. A47J 36/24; A47G 19/22

(52) U.S. Cl. CPC A47J 36/2466; A47G 2200/16; A47G 19/2288

(57) ABSTRACT

A temperature regulating fluid container assembly for regulating the temperature of a fluid positioned therein includes a cup that has a bottom wall and a perimeter wall that extends upwardly therefrom. The perimeter wall has an upper edge that defines an opening into the cup. The cup has a dividing wall therein that is spaced from the bottom wall to define a compartment between the dividing wall and the bottom wall. A temperature regulating unit is mounted on the cup and is positioned in the compartment. The temperature regulating unit is in thermal communication with an interior of the cup and detects a temperature of fluid positioned within the cup. The temperature regulating unit heats the fluid when a temperature of the fluid falls below a predetermined temperature wherein the predetermined temperature is between 120° F. and 160° F.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to heated fluid container devices and more particularly pertains to a new heated fluid container device for regulating the temperature of a fluid positioned therein.

### BRIEF SUMMARY OF THE INVENTION

An embodiment of the disclosure meets the needs presented above by generally comprising a cup that has a bottom wall and a perimeter wall that extends upwardly therefrom. The perimeter wall has an upper edge that defines an opening into the cup. The cup has a dividing wall positioned therein that is spaced from the bottom wall to define a compartment between the dividing wall and the bottom wall. A temperature regulating unit is mounted on the cup and is positioned in the compartment. The temperature regulating unit is in thermal communication with an interior of the cup and is configured to detect a temperature of fluid that is positioned within the cup. The temperature regulating unit is configured to heat the fluid when a temperature of the fluid falls below a predetermined temperature wherein the predetermined temperature is between 120° F. and 160° F.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top side view of a temperature regulating fluid container assembly according to an embodiment of the disclosure.

FIG. 2 is a side view of an embodiment of the disclosure.

FIG. 3 is a bottom view of an embodiment of the disclosure.

FIG. 4 is a cross-sectional view of an embodiment of the disclosure taken along line 4-4 of FIG. 2.

FIG. 5 is a schematic box diagram of an embodiment of the disclosure.

### DETAILED DESCRIPTION OF THE INVENTION

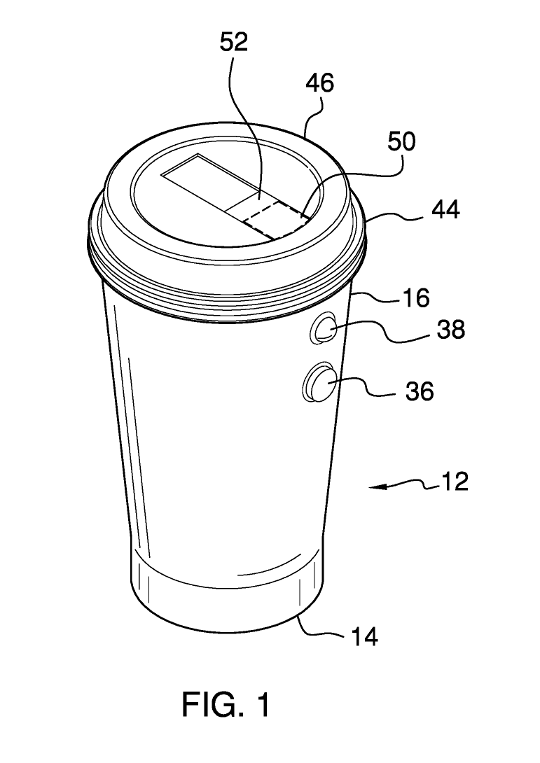

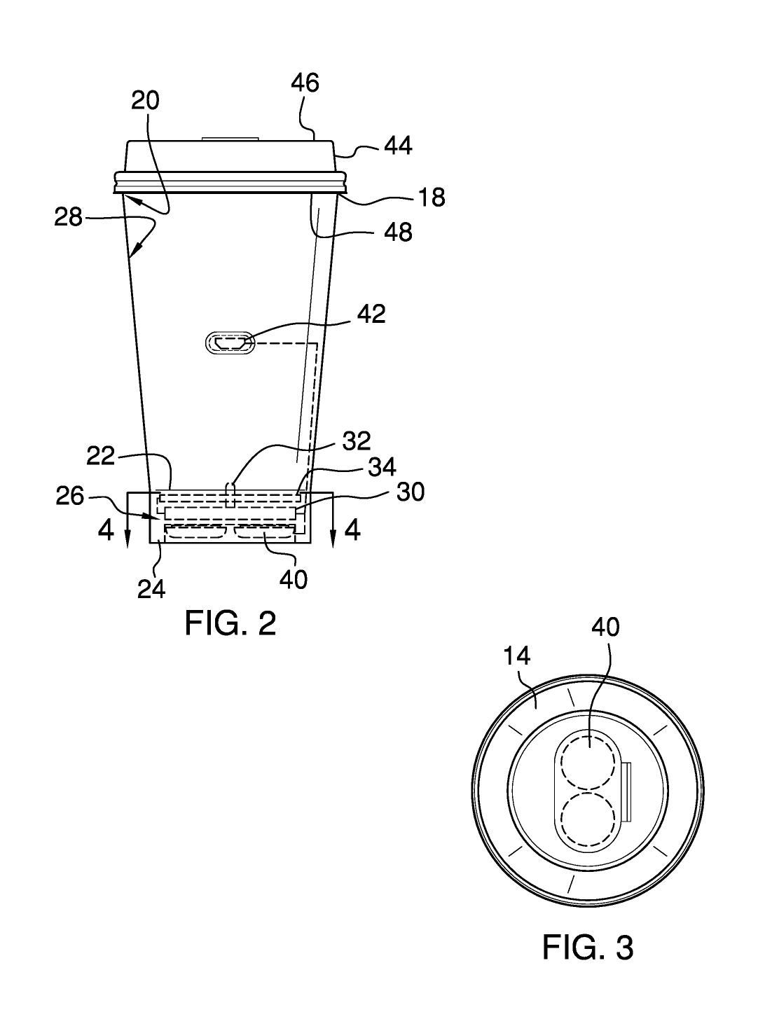

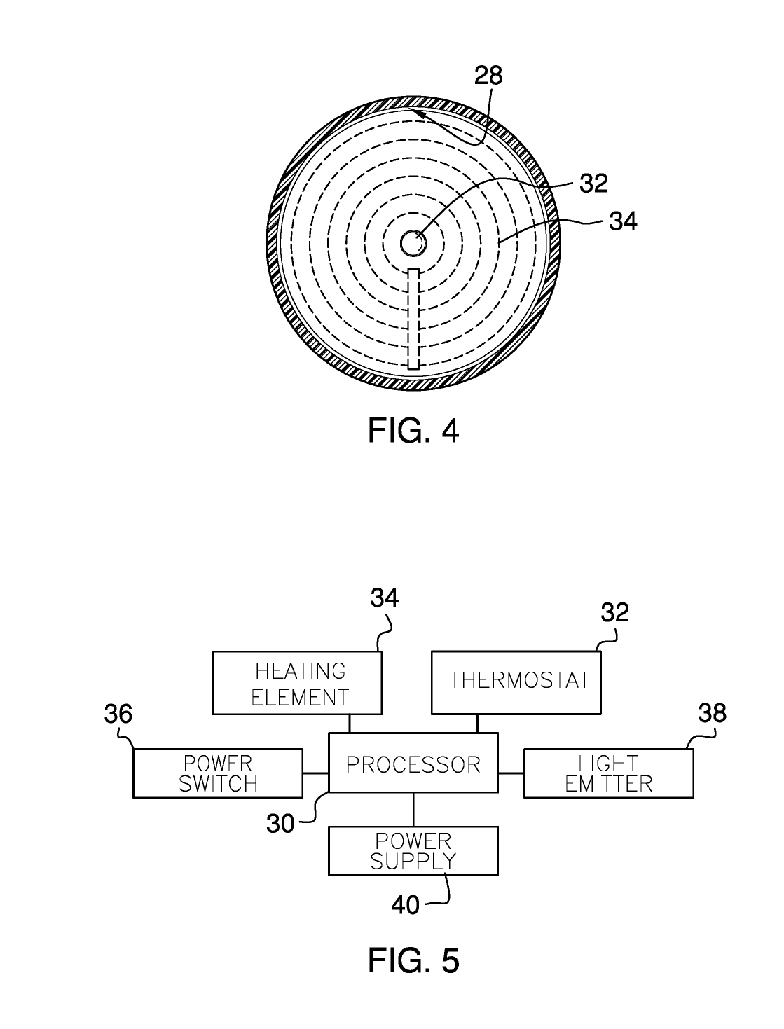

With reference now to the drawings, and in particular to FIGS. 1 through 5 thereof, a new heated fluid container device embodying the principles and concepts of an embodiment of the disclosure and generally designated by the reference numeral 10 will be described.

As best illustrated in FIGS. 1 through 5, the temperature regulating fluid container assembly 10 generally comprises a cup 12 that has a bottom wall 14 and a perimeter wall 16 that extends upwardly therefrom. The perimeter wall 16 has an upper edge 18 that defines an opening 20 into the cup 12. The cup 12 has a dividing wall 22 positioned therein that is spaced from the bottom wall 14 to define a compartment 24 between the dividing wall 22 and the bottom wall 14.

A temperature regulating unit 26 is mounted on the cup 12 and is positioned in the compartment 24. The temperature regulating unit 26 is in thermal communication with an interior of the cup 28 and detects a temperature of fluid positioned within the cup 12. The temperature regulating unit 26 heats the fluid when a temperature of the fluid falls below a predetermined temperature wherein the predetermined temperature is between 120° F. and 160° F.

The temperature regulating unit 26 comprises a processor 30 that is mounted in the cup 12. The processor 30 is programmed to allow the selection of the predetermined temperature. The predetermined temperature includes a minimum temperature sequence, a medium temperature sequence and a maximum temperature sequence. A thermostat 32 is coupled to the cup 12 and is electrically coupled to the processor 30. The thermostat 32 is in thermal communication with the fluid in the cup 12 and relays the temperature of the fluid to the processor 30.

A heating element 34 is positioned in the compartment 24. The heating element 34 is in thermal communication with the cup 12 such that the heating element 34 heats the cup 12 wherein the heating element 34 heats the fluid. The heating element 34 heats the fluid to the predetermined temperature wherein the heating element is heated to a minimum temperature when the processor 30 generates the minimum temperature sequence, to a medium temperature when the processor 30 generates the medium temperatures sequence, and to a maximum temperature when the processor 30 generates a maximum temperature sequence. The minimum temperature is equal to 130° F., the medium temperature is equal to 140° F. and the maximum temperature is equal to at least 150° F.

A power switch 36 is mounted on the cup 12. The power switch 36 is electrically coupled to the processor 30 and is actuated to turn on the processor 30 and the heating element 34. The power switch 36 is actuated sequentially to turn on the processor 30 and initiate the maximum temperature sequence, to initiate the medium temperature sequence, to initiate the minimum sequence and to turn the processor 30 off.

A light emitter 38 is mounted on the cup 12 and is electrically coupled to the processor 30. The lighter emitter 38 emits a first color when the thermostat 32 detects the temperature of the fluid to be higher than the predetermined temperature and a second color when the thermostat 32 detects the temperature is equal to or less than the predetermined temperature wherein the first color is red and the second color is green.

A power supply 40 is mounted on the cup 12 and is electrically coupled to the processor 30. The power supply 40 comprises at least one rechargeable battery. A charge port 42 is positioned on the cup 12 and is electrically coupled to the power supply 40. The charge port 42 is electrically coupled to a power source.

A lid 44 is removably positioned on the upper edge 18 to cover the opening 20. The lid 44 has a top surface 46 and a bottom surface 48. The lid 44 has a dispensing aperture 50 that extends through the top surface 46 and the bottom surface 48. A cover 52 is slidably positionable over the dispensing aperture 50.

In use, the assembly 10 is used conventionally as a cup 12. A fluid is poured into the opening 20 of the cup 12. For fluids intended to be consumed while warm, the power switch 36 is pressed to selected the desired temperature sequence. The heating element 34 is warmed to the temperature of the temperature sequence thereby 34 heating the cup 12 and to heat the fluid to the selected temperature. The thermostat 32 detects the temperature of the fluid wherein the processor 30 actuates the light emitter 38 to emit a first color if the fluid is too hot to be consumed or a second color if the fluid is equal to or less than the temperature of the selected temperature sequence.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements. I claim:

1. A temperature regulating cup assembly configured to regulate a temperature of contents in said cup, said assembly comprising:
a cup having a bottom wall and a perimeter wall extending upwardly therefrom, said perimeter wall having an upper edge, said upper edge defining an opening into said cup, said cup having a dividing wall therein being spaced from said bottom wall to define a compartment between said dividing wall and said bottom wall; and
a temperature regulating unit being mounted on said cup, said temperature regulating unit being positioned in said compartment, said temperature regulating unit being in thermal communication with an interior of said cup and configured to detect a temperature of fluid positioned within said cup, said temperature regulating unit being configured to heat the fluid when a temperature of the fluid falls below a predetermined temperature, said predetermined temperature being between 120° F. and 160° F.

2. The temperature regulating cup assembly according to claim 1, wherein said temperature regulating unit comprises:
a processor being mounted in said cup, said processor being programmed to allow selection of said predetermined temperature, said predetermined temperature including a minimum temperature sequence, a medium temperature sequence and a maximum temperature sequence; and
a thermostat being coupled to said cup and being electrically coupled to said processor, said thermostat being configured to be in thermal communication with the fluid in said cup.

3. The temperature regulating cup assembly according to claim 2, wherein said temperature regulating unit further comprises a heating element being positioned in said compartment, said heating element being in thermal communication with said cup such that said heating element heats said cup wherein said heating element is configured to heat the fluid, said heating element being configured to heat the fluid to said predetermined temperature, wherein said heating element heats to a minimum temperature when said processor generates said minimum temperature sequence, to a medium temperature when said processor generates said medium temperatures sequence, and to a maximum temperature when said processor generates a maximum temperature sequence.

5. The temperature regulating cup assembly according to claim 3, wherein said temperature regulating unit further comprises a power switch being mounted on said cup, said power switch being electrically coupled to said processor and being actuated to turn on said processor and said heating element, said power switch being actuated sequentially to turn on said processor and initiate said maximum temperature sequence, to initiate said medium temperature sequence, to initiate said minimum sequence and to turn said processor off.

6. The temperature regulating cup assembly according to claim 3, wherein said temperature regulating unit further comprises a light emitter being mounted on said cup and being electrically coupled to said processor, said lighter emitter emitting a first color when said thermostat detects the temperature of the fluid to be higher than said predetermined temperature and a second color when said thermostat detects the temperature being equal to or less than said predetermined temperature.

7. The temperature regulating cup assembly according to claim 2, wherein said temperature regulating unit comprises further including a power supply being mounted on said cup, said power supply being electrically coupled to said processor, said power supply comprising at least one rechargeable battery.

8. The temperature regulating cup assembly according to claim 7, wherein said temperature regulating unit further comprises a charge port being positioned on said cup, said charge port being electrically coupled to said power supply, said charge port being configured to be electrically coupled to a power source.

9. The temperature regulating cup assembly according to claim 2, wherein said minimum temperature being equal to 130° F., said medium temperature being equal to 140° F. and said maximum temperature being equal to at least 150° F.

10. The temperature regulating cup assembly according to claim 6, wherein said first color is red and said second color is green.

11. The temperature regulating cup assembly according to claim 1, further including a lid being removably positioned on said upper edge to cover said opening, said lid having a top surface and a bottom surface, said lid having a dispensing aperture extending through said top surface and said bottom surface.

12. The temperature regulating cup assembly according to claim 11, further including a cover being slidably positionable over said dispensing aperture.

13. The temperature regulating cup assembly configured to regulate a temperature of contents in said cup, said assembly comprising:
a cup having a bottom wall and a perimeter wall extending upwardly therefrom, said perimeter wall having an upper edge, said upper edge defining an opening into said cup, said cup having a dividing wall therein being spaced from said bottom wall to define a compartment between said dividing wall and said bottom wall;
a temperature regulating unit being mounted on said cup, said temperature regulating unit being positioned in said compartment, said temperature regulating unit being in thermal communication with an interior of said cup and configured to detect a temperature of fluid positioned within said cup, said temperature regulating unit being configured to heat the fluid when a temperature of the fluid falls below a predetermined temperature, said predetermined temperature being between 120° F. and 160° F., said temperature regulating unit comprising:
a processor being mounted in said cup, said processor being programmed to allow selection of said predetermined temperature, said predetermined temperature including a minimum temperature sequence, a medium temperature sequence and a maximum temperature sequence;
a thermostat being coupled to said cup and being electrically coupled to said processor, said thermostat being configured to be in thermal communication with the fluid in said cup;
a heating element being positioned in said compartment, said heating element being in thermal communication with said cup such that said heating element heats said cup wherein said heating element is configured to heat the fluid, said heating element being configured to heat the fluid to said predetermined temperature, wherein said heating element heats to a minimum temperature when said processor generates said minimum temperature sequence, to a medium temperature when said processor generates said medium temperatures sequence, and to a maximum temperature when said processor generates a maximum temperature sequence, said minimum temperature being equal to 130° F., said medium temperature being equal to 140° F. and said maximum temperature being equal to at least 150° F.;
a power switch being mounted on said cup, said power switch being electrically coupled to said processor and being actuated to turn on said processor and said heating element, said power switch being actuated sequentially to turn on said processor and initiate said maximum temperature sequence, to initiate said medium temperature sequence, to initiate said minimum sequence and to turn said processor off;
a light emitter being mounted on said cup and being electrically coupled to said processor, said lighter emitter emitting a first color when said thermostat detects the temperature of the fluid to be higher than said predetermined temperature and a second color when said thermostat detects the temperature being equal to or less than said predetermined temperature, said first color being red and said second color being green;
a power supply being mounted on said cup, said power supply being electrically coupled to said processor, said power supply comprising at least one rechargeable battery; and
a charge port being positioned on said cup, said charge port being electrically coupled to said power supply, said charge port being configured to be electrically coupled to a power source;
a lid being removably positioned on said upper edge to cover said opening, said lid having a top surface and a bottom surface, said lid having a dispensing aperture extending through said top surface and said bottom surface; and
a cover being slidably positionable over said dispensing aperture.
